(19) United States
(12) Patent Application Publication
(10) Pub. No.: US 2024/0245265 A1
(43) Pub. Date: Jul. 25, 2024

(54) ROBOTIC ARM ICE CREAM SCOOPING MECHANISM

(71) Applicant: NISKA RETAIL ROBOTICS PTY LTD, Sydney (AU)

(72) Inventors: Anton MORUS, Tolmie (AU); David TUMINO, Waterways (AU); Campbell MYLES, Mordialloc (AU); Deny TANUWIDJAJA, Coburg (AU); Ekaterina ORLOVA, Tolmie (AU)

(73) Assignee: NISKA RETAIL ROBOTICS PTY LTD, Sydney (AU)

(21) Appl. No.: 18/590,710

(22) Filed: Feb. 28, 2024

Related U.S. Application Data
(63) Continuation of application No. PCT/AU2022/051054, filed on Aug. 26, 2022.

(30) Foreign Application Priority Data
Aug. 30, 2021 (AU) 2021902807

(51) Int. Cl. A47J 43/28; B25J 11/00; B25J 15/00

(52) U.S. Cl. CPC A47J 43/282; B25J 11/0045; B25J 15/0019

(57) ABSTRACT

A scooping system includes a scoop and a retention system having a retention rod, where the retention system is configured to operably interface with the scoop to extend a distal end of the retention rod from a retracted position to an extended position that is within an interior of the scoop has a scoop and a retention mechanism operably interfacing the scoop.

### CROSS-REFERENCE TO RELATED APPLICATIONS

This application is a continuation of International Application No. PCT/AU2022/051054, filed on Aug. 26, 2022, which claims the benefit under 35 USC 119(a) and 365(b) of Australian Patent Application No. 20/219,02807, filed on Aug. 30, 2021, in the Australian Intellectual Property Office, the entire disclosures of which are incorporated herein by reference for all purposes.

### BACKGROUND

### 1. Field

The following description may relate to robotic arm ice cream scooping mechanisms.

### 2. Description of Related Art

Robotic ice cream serving stations involve an ice cream scoop manoeuvred by a robotic arm including that which is disclosed in WO/2020/024018 (Morus et al.) Feb. 6, 2020 by the present applicant, the entire disclosure of which is incorporated herein by reference.

Problems exist when ice cream is accidentally dropped from the scoop prior proper depositing in a serving receptacle, a problem compounded by variability in ice cream density and viscosity. This problem may be somewhat ameliorated by careful manoeuvring of the scoop by the robotic arm but not eliminated entirely.

The present disclosure may provide a way, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY

There is provided herein an ice cream scooping mechanism which may be manoeuvred by a robotic arm. The mechanism has a scoop within which ice cream is scooped by the robotic arm in use.

The mechanism further has a retention mechanism operably interfacing the scoop. The retention mechanism has a retention rod operative between an extended position where the retention rod extends into an interior of the scoop and a retracted position.

The scoop may further comprise a wiper blade which wipes an interior surface of the scoop to dislodge scooped ice cream therefrom.

A controller may control the robotic arm and the scooping mechanism to serve scoops of ice cream.

Firstly, the controller would control the robotic arm to manoeuvre the scoop to scoop a scoop of ice cream from an ice cream tub or the like.

Once a scoop of ice cream is obtained, the controller would operate the retention mechanism to extend the retention rod into the scoop. The distal end of the retention rod punches into the scoop of ice cream within the scoop against a distal end wall of the scoop thereby holding the ice cream in the scoop.

Thereafter, the controller controls the robotic arm to manoeuvre the scooping mechanism to the serving receptacle.

During this manoeuvre, the retention rod prevents the ice cream from accidentally being dropped from the scoop.

Once the scoop is positioned above the serving receptacle, the controller would operate the retention mechanism to retract the retention rod so that the ice cream is free to fall from the scoop to the serving receptacle.

The controller may additionally control the wiper blade to wipe the interior surface of the scoop to ensure that the scoop of ice cream therein is dislodged to the serving receptacle.

As the wiper blade may wipe across the path of the retention rod, the controller may be configured to ensure that the wiper blade is not operated whilst the retention what is extended.

Other features and aspects will be apparent from the following detailed description, the drawings, and the claims.

### BRIEF DESCRIPTION OF THE DRAWINGS

FIG. 1 shows a perspective internal view of an ice cream scooping mechanism (i.e., scooping system), in accordance with one or more embodiments;

FIG. 2 shows a perspective view of an ice cream scooping mechanism with a retention rod thereof and a retracted position, in accordance with one or more embodiments;

FIG. 3 shows a perspective view of an ice cream scooping mechanism with the retention rod in an extended position, in accordance with one or more embodiments;

FIG. 4 shows a top plan view of an ice cream scooping mechanism with the retention rod in the extended position, in accordance with one or more embodiments; and

FIG. 5 shows a side elevation view of an ice cream scooping mechanism, in accordance with one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order (e.g., a certain order). Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

An ice cream scooping mechanism 100 has a scoop 102 for scooping ice cream therein. The mechanism 100 may be affixed to a distal end of a robotic arm (not shown) for automatic serving of ice cream such as in a retail environment.

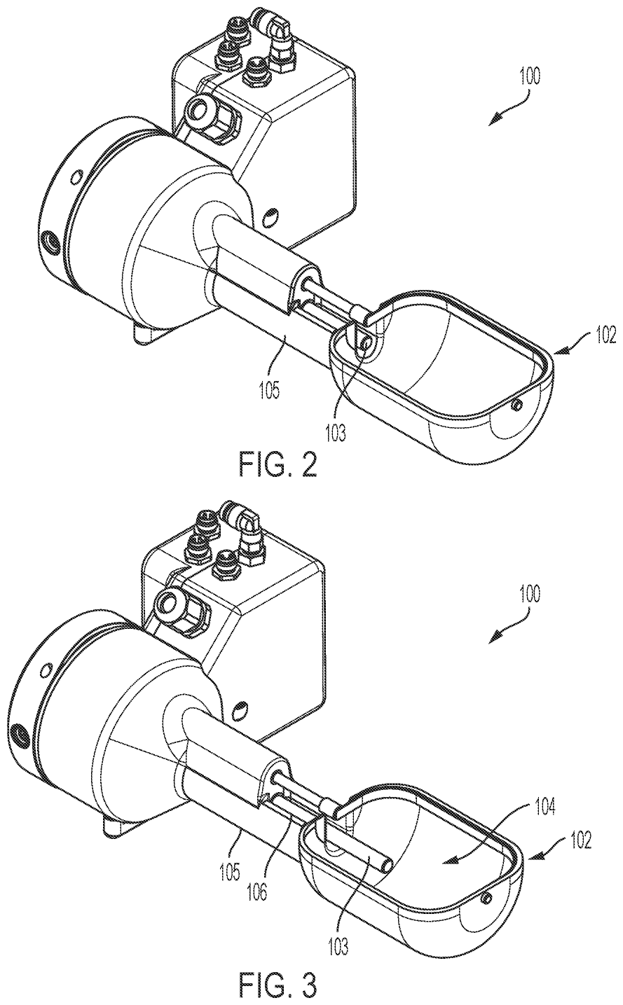

The mechanism 100 has a retention mechanism operably interfacing the scoop. The retention mechanism has a retention rod 103 operable between an extended position as shown in FIG. 3 where the retention rod 103 extends into an interior 104 of the scoop 102 and a retracted position shown in FIG. 2.

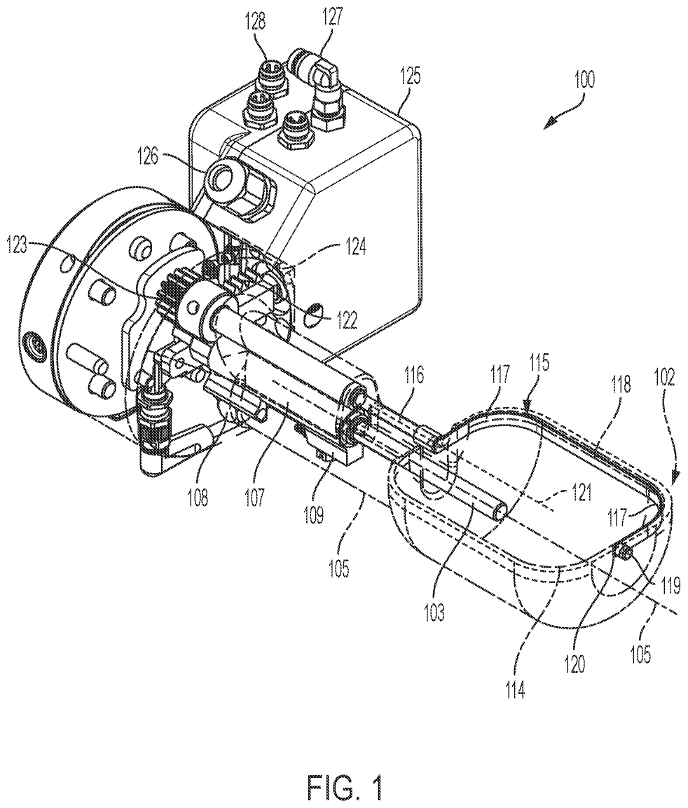

As shown in FIG. 1, the retention rod 103 may extend and retract along a longitudinal axis 105 of the retention rod 103.

The mechanism 100 may comprise a stem 105 having the scoop 102 at a distal end thereof. The scoop 102 may define an opening defined by a rim 114 thereof to one side of the stem 105. The rim 114 may be coplanar.

The retention rod 103 may retract along the stem 105 when in the retracted position. Whereas the retention rod 103 may retract within an interior of the stem 105 in an embodiment, in the embodiment shown, the stem 105 defines an open channel 106 along which the retention rod 103 reciprocates.

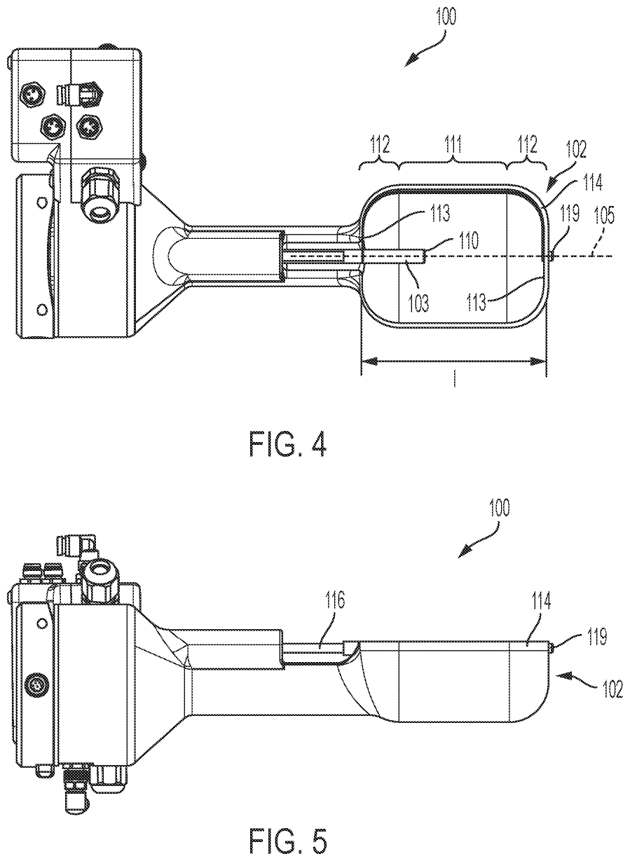

As shown in FIG. 4, the scoop 102 may have a length l along the longitudinal axis 105 of the retention pin 103 and, in the extended position shown, the distal end 110 of the retention rod 103 may extend more than a quarter of the length of the scoop 102.

The scoop 102 may further define a cylindrical midsection 111 and curved end sections 112 which transition from the cylindrical midsection 111 to end walls 113 of the scoop 102. As is further shown in FIG. 4, the distal end 110 of the retention rod 113 may extend beyond the proximal end section 112 partway across the cylindrical midsection 111.

The retention rod 103 may be reciprocated by a pneumatic cylinder 107. The pneumatic cylinder 107 may be pressurised to drive the retention rod 103 in both directions. In other words, the pneumatic cylinder 107 may comprise a base port 108 for extending the retention rod 103 and a rod port 109 for retracting the retention rod 103. In alternative embodiments, the retention rod 103 may be reciprocated by an electromechanical mechanism such as annular solenoid, electric motor driven pinion acting on a rack or the like.

The mechanism 100 may further comprise a wiper mechanism which dislodges ice cream from the scoop 102 in use. The wiper mechanism may comprise a wiper blade 115 which turns eccentrically with respect to a wiper blade driveshaft 116. The wiper blade 115 may conform closely to the interior curvature of the scoop 102 wherein the blade 115 comprises proximal and distal curved end sections 117 which conform to the interior surface curvature of the respective curve end sections 112 and a straight midsection 118 which conforms to the interior surface curvature of the cylindrical midsection 111.

The distal end of the wiper blade 118 may be journaled to a distal end of the scoop 102 by a short axle 119 extending through an aperture 120 of the distal end wall 113 of the scoop 102.

As is shown in FIG. 1, the longitudinal axis 105 of the retention rod 103 may locate deeper in the scoop 102 as compared to a rotational axis 121 of the wiper blade 115. As such, the proximal curved end section 117 of the blade 115 wipes across the path of the retention rod 103. As such, the mechanism 100 may be controlled by a controller (e.g., herein, one or more processors) which does not turn the wiper driveshaft 116 when the retention rod 103 is in the extended position. In other words, the controller would only turn the driver wiper shaft 116 when the retention rod 103 is in the retracted position.

The wiper driveshaft 116 may be turned by a toothed rack 122 driven orthogonally with respect to the rotational axis 116 to turn a pinion gear 123. The rack 122 may be reciprocated by a pneumatic cylinder 124. The pneumatic cylinder 124 may similarly be driven in both directions in comprising a base port for extending the rack 122 to wipe the blade 115 in one direction and a rod port for retracting the rack 122 to wiper blade 115 and an opposite direction, thereby ensuring that the retention rod 103 can be pulled from the scoop of ice cream.

The mechanism 100 may comprise an interface box housing 125 which may comprise a pressurised air inlet 126, exhaust 127 and a plurality of electrical plugs 128 for opening and closing pneumatic solenoids to drive the pistons 107, 124.

The controller may control the robotic arm and the scooping mechanism 100 to scoop and deposit scoops of ice cream. Firstly, the controller would manoeuvre the scooping mechanism 100 to scoop ice cream into the scoop 102 from an ice cream tub or the like.

Thereafter, the controller would operate the retention mechanism to extend the retention rod 103 to the extended position. The distal end 110 of the retention rod 103 punches into the ice cream scoop within the scoop 102 against the distal end wall 113 of the scoop 102.

Thereafter, the controller may manoeuvre the scooping mechanism 100 to position the scoop 102 above a serving receptacle, such as a scoop, bowl, cone or the like.

During this manoeuvre, the retention rod 103 prevents the ice cream from dropping from the scoop 102.

Thereafter, the controller would operate the retention mechanism to retract the retention rod 103 to the retracted position so that the ice cream within the scoop 102 is no longer retained by the retention rod 103.

Once the retention rod 103 is in the retracted position, the controller may further operate the wiper mechanism to wipe the wiper blade 115 across the interior surface of the scoop 102 to ensure that the ice cream therein is dislodged from the scoop 102.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A scooping system, comprising:
a scoop; and
a retention system comprising a retention rod, the retention system being configured to operably interface with the scoop to extend a distal end of the retention rod from a retracted position to an extended position that is within an interior of the scoop.

2. The scooping system of claim 1, wherein the extension of the distal end of the retention rod from the retracted position to the extended position is along a longitudinal axis of the retention rod.

3. The scooping system of claim 2, further comprising a stem,
wherein the scoop is positioned at a distal end of the stem, and
wherein the retracted position lies along the stem.

4. The scooping system of claim 3, wherein the stem includes an exposed channel that the retention rod longitudinally reciprocates within.

5. The scooping system of claim 3, wherein the scoop is open at one side with respect to a longitudinal axis of the stem.

6. The scooping system of claim 3, wherein the retention system further comprises a pneumatic cylinder, adjacent to the stem, configured to reciprocate the retention rod.

7. The scooping system of claim 6, wherein the pneumatic cylinder has a base port for extending the distal end of the retention rod to the extension position and a rod port for retracting the distal end of the retention rod to the retracted position.

8. The scooping system of claim 1, wherein the scoop has a coplanar rim.

9. The scooping system of claim 1, wherein, when the distal end of the retention rod is at the extended position, the distal end of the retention rod extends more than a quarter of a total length, corresponding to a longitudinal axis of the retention rod, of the scoop into the interior of the scoop.

10. The scooping system of claim 1,
wherein the scoop comprises a cylindrical midsection and a curved proximal section, and
wherein, when the distal end of the retention rod is at the extended position, the retention rod extends across the cylindrical midsection along a longitudinal axis of the retention rod.

11. The scooping system of claim 1, further comprising a wiper driveshaft and a wiper blade configured to, under rotational control of the wiper driveshaft, wipe an interior surface of the scoop,
wherein the scoop has a semicylindrical shape.

12. The scooping system of claim 11, wherein a longitudinal axis of the retention rod is located further from a rim of the scoop than a rotational axis of the wiper blade.

13. The scooping system of claim 12, further comprising a controller configured to control the wiper driveshaft to not turn when the retention rod is at the extended position.

14. The scooping system of claim 12, wherein the wiper driveshaft is configured to turn by a toothed rack that runs orthogonal to the wiper driveshaft and interfaces a pinion of the wiper driveshaft.

15. The scooping system of claim 14, further comprising a pneumatic cylinder,
wherein the rack is configured to be reciprocated by the pneumatic cylinder.

16. The scooping system of claim 15, wherein the pneumatic cylinder has a base port configured to extend the rack and a rod port configured to retract the rack.

17. The scooping system of claim 1, further comprising:
a robotic arm configured to manipulate the scoop and the retention support based on control of a controller; and
the controller configured to:
control the robotic arm to maneuver the scoop to collect material into the interior of the scope;
control the retention system to extend the distal end of the retention rod into the collected material to the extended position;
control the robotic arm to maneuver the scoop, with the distal end of the retention rod extended into the collected material, to be positioned above a serving receptacle; and
control the retention system to retract the distal end of the retention rod from the collected material to the retracted position.

18. The scooping system of claim 17, further comprising a wiper driveshaft and a wiper blade,
wherein a longitudinal axis of the retention rod is located further from a rim of the scoop than a rotational axis of the wiper blade,
wherein the controller is further configured to control, upon the distal end of the retention rod having retracted from the collected material to the retracted position, the wiper driveshaft to rotate to cause the wiper blade to wipe an interior surface of the scoop to remove the collected material from the interior of the scoop, and
wherein the scoop has a semicylindrical shape.
